(19) United States
(12) Patent Application Publication
(10) Pub. No.: US 2004/0256878 A1
(43) Pub. Date: Dec. 23, 2004

(54) Fragmentation-resistant instrument panel and method of making same

(75) Inventors: Nadav Rave, Malvern, PA (US); Ismael Rodriguez, West Chester, PA (US); Roland Ewaniuk, Newtown Square, PA (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(73) Assignee: JSP LICENSES, INC., Wilmington, DE

(21) Appl. No.: 10/600,552

(22) Filed: Jun. 20, 2003

(51) Int. Cl. B62D 25/14

(52) U.S. Cl. 296/70

(57) ABSTRACT

A fragmentation-resistant instrument panel for use in a vehicle is provided which includes an outer layer having an inner surface and a core of expanded plastic of a predetermined shape and having an inner surface. The core is secured to the inner surface of the outer layer. The inner layer has an inner surface fixedly secured to the inner surface of the core to thereby at least partially encapsulate the expanded plastic foam between it and the outer layer. The instrument panel is resistant to fragmentation in the event that an impact force is applied to the inner layer. A method of making the instrument panel is also provided.

### BACKGROUND OF THE INVENTION

This invention relates generally to interior trim panels for motor vehicles, and, more particularly, to interior trim panels located adjacent to vehicle air bag assemblies.

Supplemental air restraint systems (SIRs) are well known for use in motor vehicles.

Such SIRs typically include a driver air bag mounted on the steering wheel and a passenger air bag mounted on the instrument panel forward of the passenger seating position. SIRS may be located in other positions as well.

It is well known to mount the passenger air bag beneath the top surface of the instrument panel and to provide an air bag deployment opening within the padded instrument panel cover. The deployment opening in the instrument panel cover is closed by an air bag door which opens in response to air bag deployment to permit the air bag to deploy into the passenger compartment.

The present invention is directed generally to an instrument panel mounted air bag which may deploy into the passenger compartment without the provision of an opening in the instrument panel.

Conventional upper automotive instrument panels of this type are designed to facilitate the deployment of the SIR system. These panels are typically comprised of many layers of material including “foils” (the outer, exposed covering layer which is described in greater detail below), soft core materials, rigid substrate materials and reinforcing components. Many types of designs are in current use, but substantially all types must perform to industry and government standards and requirements. One such requirement is that during the deployment event, no fragmentation of materials used in panel construction may occur so as to violate the interior space of the vehicle and result in possible occupant injury.

For example, U.S. Pat. No. Re. 36,167 (Barnes), is directed to an air bag deployable instrument panel cover. Here, an air bag module is mounted on the instrument panel structure forwardly of the passenger seating position. An instrument panel cover is mounted atop the instrument panel to conceal the air bag from view. The instrument panel cover is fastened to the instrument panel structure by fasteners which include detachable fasteners provided in the portion of the instrument panel cover forward of the passenger to permit the air bag to lift the instrument panel cover upwardly away from the instrument panel structure upon air bag inflation. The forward edge (toward the front of the vehicle) of the instrument panel is fixed to the vehicle body structure. FIG. 4 depicts this prior art instrument panel.

Many materials, methods, and designs are currently in use on today's vehicles for such instrument panels. Generally, all of these incorporate conventional manufacturing materials and constructions. The use of these conventional technologies dictates that the product, in order to meet requirements, be of a highly structured, mass intensive, and costly design. The present invention substitutes an expanded polypropylene (EPP) base material for current materials and results in many advantages to the automotive manufacturer. EPP is well known and is a very low mass material resulting in gross vehicle weight reduction and prime material savings. The incorporation of the design of the present invention assures the reliability of the product and its ability to pass performance requirements. With performance criteria met, a lower price, lower mass, higher quality product is available.

The construction of an instrument panel, as referred to herein, uses EPP as a core material which is backmolded behind an appearance foil in a steam chest process. However, it is possible that, upon deployment of the SIR, the EPP core material may, in some cases, fracture causing separation of loose particles which violated the interior space of a motor vehicle. The present invention provides a solution to this problem.

All references cited herein are incorporated herein by reference in their entireties.

### BRIEF SUMMARY OF THE INVENTION

A fragmentation-resistant instrument panel for use in a vehicle is provided that includes an outer layer having an inner surface and a core of expanded plastic of a predetermined shape and having an inner surface. The core is secured to the inner surface of the outer layer. The instrument panel further includes an inner layer having an inner surface fixedly secured to the inner surface of the core to thereby at least partially encapsulate the expanded plastic foam between it and the outer layer. The instrument panel will be resistant to fragmentation in the event that an impact force is applied to the inner layer.

The expanded plastic foam may include a plurality of small polypropylene beads that are joined to one another by the application of heat thereto. The outer layer may be, for example, a textile, a thermoplastic polyolefin, or a polyvinylchloride. The outer layer may be, for example, a laminate having an inner ply of a cross-linked polypropylene, cross-linked polyethylene, polyurethane, thermoplastic polyolefin, or polypropylene. In addition to being a single layer, the outer layer may also be, for example, a bilaminate or a trilaminate, as are well known.

The instrument panel may additionally include an expandable air bag forming a portion of a supplemental restraint system mounted adjacent to the inner layer.

The inner layer may be, for example, a thermoplastic film material and may be reinforced with one or more textiles.

A method of manufacturing a fragmentation-resistant instrument panel for use in a vehicle is also provided which includes the steps of providing an outer layer having an inner surface, molding a plurality of plastic beads into an expanded plastic foam core of a predetermined shape and having an inner surface, securing the core of expanded plastic foam to the inner surface of the outer layer, and fixedly securing an inner layer of material onto the inner surface of the core to thereby at least partially encapsulate the expanded plastic foam between it and the outer layer. Again, the instrument panel will be resistant to fragmentation in the event that an impact force is applied to the inner layer.

The step of molding a plurality of plastic beads into an expanded plastic foam may include molding a plurality of small polypropylene beads that are joined to one another by the application of heat thereto, for example, in a steam chest molding process. The steps of molding a plurality of plastic beads into an expanded plastic foam core, securing the core of expanded plastic foam to the inner surface of the outer layer, and fixedly securing an inner layer of material onto the inner surface of the core may occur in a single step using a steam chest molding process. The step of providing the outer layer may include providing the outer layer of, for example, a textile, thermoplastic polyolefin, or polyvinylchloride. The step of providing the outer layer may include providing, for example, a laminate having an inner ply comprising cross-linked polypropylene, cross-linked polyethylene, polyurethane, thermoplastic polyolefin, or polypropylene.

The method may further include the step of providing an expandable air bag forming a portion of a supplemental restraint system mounted adjacent to the inner layer.

The outer layer may be, for example, a single layer, a bilaminate or trilaminate. The inner layer may be, for example, a thermoplastic film material that may be reinforced with one or more textiles.

### BRIEF DESCRIPTION OF SEVERAL VIEWS OF THE DRAWINGS

The invention will be described in conjunction with the following drawings in which like reference numerals designate like elements throughout the several views and wherein:

FIG. 1 is a front isometric view of a fragmentation resistant instrument panel in accordance with one preferred embodiment of the present invention, showing the foil side of the instrument panel;

FIG. 2 is a rear isometric view of the fragmentation resistant instrument panel of FIG. 1;

FIG. 3 is a cross-sectional view of the fragmentation-resistant instrument panel of FIG. 1, taken substantially along line 3--3 of FIG. 1; and

FIG. 4 is an example of a prior art instrument panel of the general type of one preferred embodiment of the present invention.

### DETAILED DESCRIPTION OF THE INVENTION

In accordance with the present invention, a reliable solution to problems associated with fragmentation of an instrument panel upon deployment of an air bag is provided which incorporates a film layer that is adhered to at least part of the back side of the instrument panel. This film layer would serve to at least partially encapsulate and contain fragmented particles during SIR deployment by entrapping the fragmented particles between the outer foil and the film layer on the back side of the instrument panel. The film layer also serves to further strengthen the composite and to eliminate or reduce fractures.

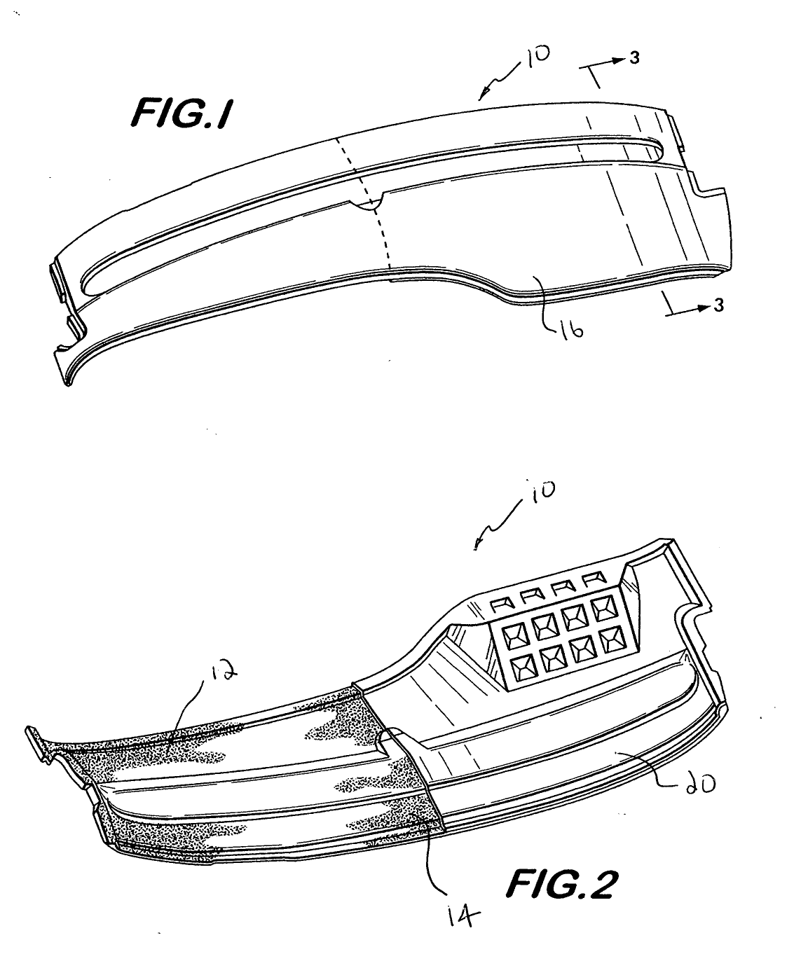

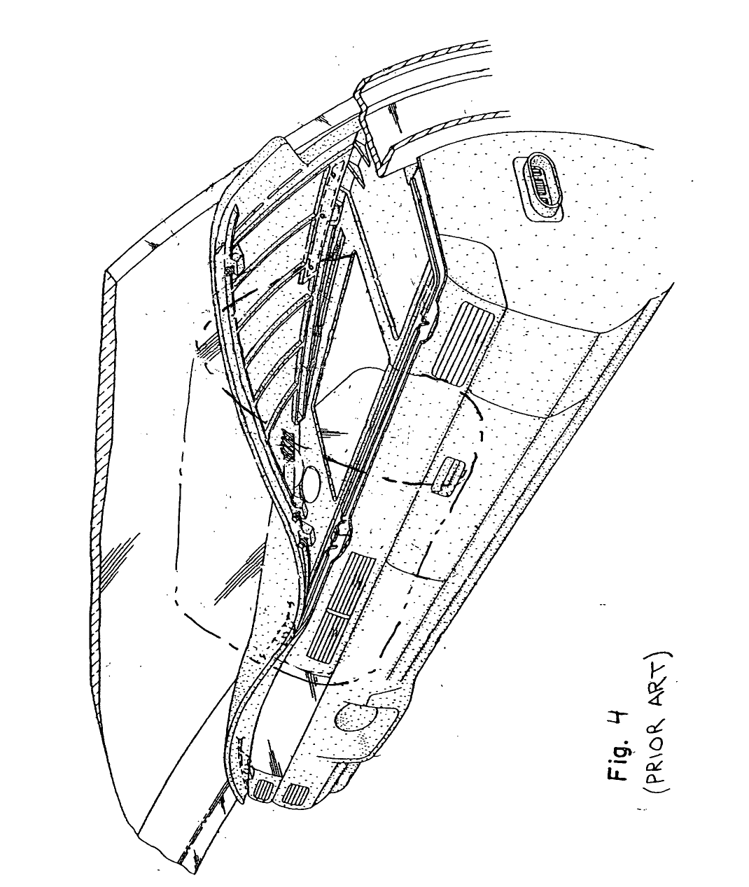

Referring now to the drawings, wherein like part numbers refer to like elements throughout the several views, there is shown in FIGS. 1 and 2 a fragmentation resistant instrument panel 10 for use in a vehicle in accordance with one preferred embodiment of the present invention. The instrument panel generally is of a type as shown, for example, in U.S. Pat. No. Re. 36,167 which is fully incorporated herein by reference. FIG. 4 shows such an instrument panel. However, the present invention is intended to be used with numerous other types of instrument panels.

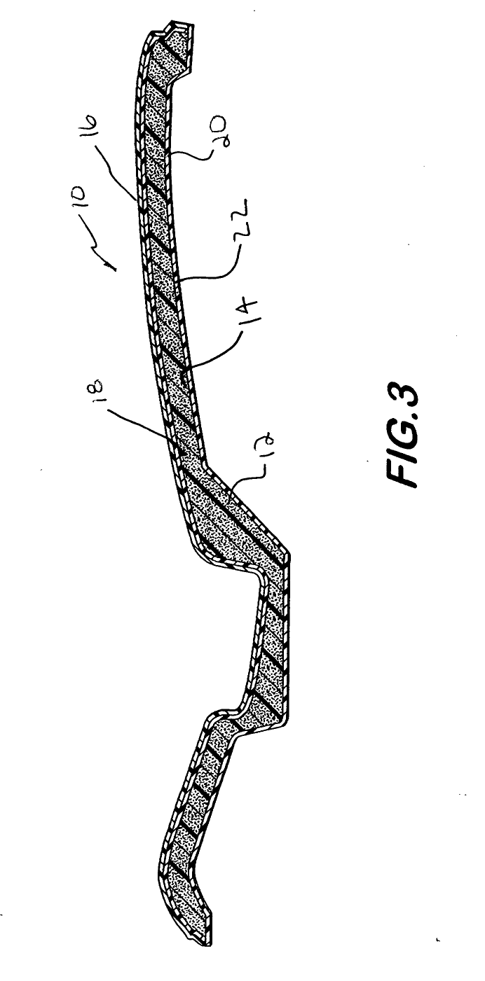

As can be seen in FIG. 1-3, the instrument panel 10 includes a core 12 constructed of, for example, expanded plastic. The core 12 is fabricated in mold in a predetermined shape suitable for use as an instrument panel 10. The core 12 has an inner surface 14. The instrument panel 10 further includes a foil (outer layer 16) which has an inner surface 18. The core 12 is secured to the inner surface 18 of the outer layer 16. A film layer (inner layer 20) having an inner surface 22 is fixedly secured to the inner surface 14 of the core 12 to at least partially encapsulate the expanded plastic foam of the core 12 between the inner layer 20 and the outer layer 16.

The present invention preferably applies to an upper instrument panel cover panel. However, other uses where fragmentation is to be avoided are intended to be included within the scope of the present invention. The construction of the preferred instrument panel 10 includes a “foil” cover material (i.e., the outer layer 16), an EPP foam core 12 and a backside material or film) (i.e., the inner layer 20) . The product is preferably manufactured using steam chest molding technology, as is well known. Generally, in a steam chest molding process, articles such as foamed boards or sheets are molded from expanded foam material, such as polystyrene. A cavity is filled with beads of the partially expanded polystyrene and steam is used to completely expand the beads. The foam is then cooled with water.

The foil (outer layer 16) on the visible surface can be a textile, a thermoplastic polyolefin (TPO), or a polyvinyl chloride (PVC) or similar material known in the art. The outer layer 16 may have multiple layers. For example, outer layer 16 may have a backing material such as crosslinked polypropylene (XLPP), crosslinked polyethylene (XLPE), polyurethane (PU), thermoplastic polyolefin (TPO), or polypropylene (PP) bonded to them prior to being backmolded with expanded polypropylene (EPP). That is, the outer layer 16 may be, for example, a single layer, a bilaminate, a trilaminate, or the like, as well known in the art.

The outer layer 16 may be applied in the one step steam chest molding operation by introducing the film sheeting into the mold space onto the core half of the mold during machine cycle and using the heated environment of the core chamber to fusion bond the outer layer 160. The outer layer 16 may otherwise be applied to the backside as a post molding operation using conventional heat bonding equipment and tooling such as sonic welding, heated air, or vibration welding.

The film material applied to the underside of the panel (i.e., the inner layer 20) may be a thermoplastic film material. Optionally, this film may be reinforced with one or more textiles. This material may be assembled as a one step process in the steam chest molding process or as a post molding operation using a heat bonding process. The resin film material applied to the backside of the panel serves to create an envelope which when coupled with the foil (outer layer 20) on the visible side of the instrument panel 10 serves to at least partially encapsulate the EPP core material (of core 12). This encapsulation feature serves to contain any loose or fractured fragments of EPP core material which may separate from parent material during the deployment of the vehicle's SIR system and thus perform as required. The resin film may be applied in the one step steam chest molding operation by introducing the film sheeting into the mold space onto the core half of the mold during machine cycle and using the heated environment of the core chamber to fusion bond the film. The film may otherwise be applied to the backside as a post molding operation using conventional heat bonding equipment and tooling such as sonic welding, heated air, or vibration welding.

While the invention has been described in detail and with reference to specific embodiment discussed herein, it will be apparent to one skilled in the art that various changes and modifications can be made therein without departing from the spirit and scope thereof.

1. A fragmentation-resistant instrument panel for use in a vehicle comprising:
(a) an outer layer having an inner surface,
(b) a core of expanded plastic of a predetermined shape and having an inner surface, said core secured to said inner surface of said outer layer, and
(c) an inner layer film having an inner surface fixedly secured to a substantial portion of said inner surface of said core to thereby at least partially encapsulate said expanded plastic foam between it and said outer layer,
whereby said instrument panel will be resistant to fragmentation in the event that an impact force is applied to said inner layer.

2. The fragmentation-resistant instrument panel of claim 1 wherein said expanded plastic foam comprises a plurality of small polypropylene beads that are joined to one another by the application of heat thereto.

3. The fragmentation-resistant instrument panel of claim 1, wherein said outer layer comprises a material selected from the group consisting of textiles, thermoplastic polyolefins and polyvinylchloride.

4. The fragmentation-resistant instrument panel of claim 2, wherein said outer layer comprises a material selected from the group consisting of textiles, thermoplastic polyolefins and polyvinylchloride.

5. The fragmentation-resistant instrument panel of claim 1, wherein said outer layer comprises a laminate having an inner ply comprising a material selected from the group consisting of cross-linked polypropylene, cross-linked polyethylene, polyurethane, thermoplastic polyolefin, and polypropylene.

6. The fragmentation-resistant instrument panel of claim 2 wherein said outer layer comprises a laminate having an inner ply comprising a material selected from the group consisting of cross-linked polypropylene, cross-linked polyethylene, polyurethane, thermoplastic polyolefin, and polypropylene.

7. The fragmentation-resistant instrument panel of claim 3 wherein said outer layer comprises a laminate having an inner ply comprising a material selected from the group consisting of cross-linked polypropylene, cross-linked polyethylene, polyurethane, thermoplastic polyolefin, and polypropylene.

8. The fragmentation-resistant instrument panel of claim 4 wherein said outer layer comprises a laminate having an inner ply comprising a material selected from the group consisting of cross-linked polypropylene, cross-linked polyethylene, polyurethane, thermoplastic polyolefin, and polypropylene.

9. The fragmentation-resistant instrument panel of claim 1, wherein the outer layer is a bilaminate.

10. The fragmentation-resistant instrument panel of claim 1, wherein the outer layer is a trilaminate.

11. The fragmentation-resistant instrument panel of claim 1, additionally comprising an expandable air bag forming a portion of a supplemental restraint system mounted adjacent said inner layer.

12. The fragmentation-resistant instrument panel of claim 1, wherein the inner layer is a thermoplastic film material.

13. The fragmentation-resistant instrument panel of claim 1, wherein the inner layer is reinforced with one or more textiles.

14. A method of manufacturing a fragmentation-resistant instrument panel for use in a vehicle, comprising the steps of:
(a) providing an outer layer having an inner surface;
(b) molding a plurality of plastic beads into an expanded plastic foam core of a predetermined shape and having an inner surface;
(c) securing the core of expanded plastic foam to the inner surface of the outer layer; and
(d) fixedly securing an inner layer of material onto the inner surface of the core, to thereby at least partially encapsulate the expanded plastic foam between it and the outer layer;
whereby the instrument panel will be resistant to fragmentation in the event that an impact force is applied to the inner layer.

15. The method of claim 14, wherein the step of molding a plurality of plastic beads into an expanded plastic foam comprises molding a plurality of small polypropylene beads that are joined to one another by the application of heat thereto.

16. The method of claim 14, wherein the step of molding a plurality of plastic beads into an expanded plastic foam comprises molding a plurality of small polypropylene beads that are joined to one another in a steam chest molding process.

17. The method of claim 14, wherein the steps of molding a plurality of plastic beads into an expanded plastic foam core, securing the core of expanded plastic foam to the inner surface of the outer layer, and fixedly securing an inner layer of material onto the inner surface of the core, occur in a single step using a steam chest molding process.

18. The method of claim 14, wherein the step of providing the outer layer comprises providing a material selected from the group consisting of textiles, thermoplastic polyolefins and polyvinylchloride.

19. The method of claim 15, wherein the step of providing the outer layer comprises providing a material selected from the group consisting of textiles, thermoplastic polyolefins and polyvinylchloride.

20. The method of claim 16, wherein the step of providing the outer layer comprises providing a material selected from the group consisting of textiles, thermoplastic polyolefins and polyvinylchloride.

21. The method of claim 17, wherein the step of providing the outer layer comprises providing a material selected from the group consisting of textiles, thermoplastic polyolefins and polyvinylchloride.

22. The method of claim 14, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

23. The method of claim 15, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

24. The method of claim 16, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

25. The method of claim 17, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

26. The method of claim 18, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

27. The method of claim 19, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

28. The method of claim 18, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

29. The method of claim 19, wherein the step of providing the outer layer comprises providing a laminate having an inner ply comprising a material selected from the group consisting of cross-linked polypropylene, cross-linked polyethylene, polyurethane, thermoplastic polyolefin, and polypropylene.

30. The method of claim 14, further including a step of providing an expandable air bag forming a portion of a supplemental restraint system mounted adjacent the inner layer.

31. The fragmentation-resistant instrument panel of claim 14, wherein the outer layer is a bilaminate.

32. The fragmentation-resistant instrument panel of claim 14, wherein the outer layer is a trilaminate.

33. The fragmentation-resistant instrument panel of claim 14, wherein the inner layer is a thermoplastic film material.

34. The fragmentation-resistant instrument panel of claim 14, wherein the inner layer is reinforced with one or more textiles.
